(19) United States
(12) Patent Application Publication
(10) Pub. No.: US 2026/0226844 A1
(43) Pub. Date: Aug. 6, 2026

(54) BIDIRECTIONAL FLOWTHROUGH TURBOEXPANDER

(71) Applicant: Calnetix Technologies, LLC, Cerritos, CA (US)

(72) Inventors: Jeffrey Earl, Hermosa Beach, CA (US); Jeremy Liu, Cerritos, CA (US); Steve Richards, Cerritos, CA (US); Venky Krishnan, Los Alamitos, CA (US)

(21) Appl. No.: 19/047,503

(22) Filed: Feb. 6, 2025

(51) Int. Cl. F01D 15/10; H02K 7/09; H02K 7/18; H02K 11/04; H02K 21/14

(52) U.S. Cl. CPC F01D 15/10; H02K 7/09; H02K 7/1823; H02K 11/04; H02K 21/14; F05D 2220/20; F05D 2220/30; F05D 2220/7642; F05D 2220/768

(57) ABSTRACT

An electric power generation system includes a turboexpander generator with a first gas conduit and a flow wheel connected to the first gas conduit. The flow wheel is configured to rotate in response to gas expanding through the flow wheel during an expansion mode of operation and to rotate to compress gas during an compression mode of operation. An electric rotor is coupled to the flow wheel and resides within a stator. A second gas conduit is opposite the flow wheel from the first gas conduit. A first valve is coupled to the first gas conduit, the first valve controllable during an expansion mode to selectively permit gas to flow from a first direction towards the first gas conduit. A second valve coupled to the second gas conduit, the second valve controllable during a compression mode to selectively permit gas to flow from a second direction towards the second gas conduit.

### BACKGROUND

Natural gas is one of the principal sources of energy for many of our day-to-day needs and activities. Natural gas is an attractive fossil fuel for its abundance and relative cleanliness. Hydrogen is a rapidly expanding global energy storage market. Hydrogen is used in many manufacturing processes from petroleum refining to food processing. Hydrogen is also used as a fuel source for gas turbines and in a broad range of fuels cells to generate electricity in industrial and consumer transportation sectors.

The efficient and effective movement of such gases from producing regions to consumption regions requires an extensive and elaborate transportation system. Gas that is transported through pipelines travels at high pressure in the pipeline.

### SUMMARY

Certain aspects encompass an electric power generation system having a turboexpander generator. The turboexpander generator has a first gas conduit and a flow wheel. The flow wheel is configured to rotate in response to gas expanding through the flow wheel during an expansion mode of operation and to rotate to compress gas during an compression mode of operation. The turboexpander generator also has an electric rotor coupled to the flow wheel and configured to rotate with the flow wheel and a stator having a plurality of stator coils resides around the rotor. The rotor has a plurality of permanent magnets. The turboexpander generator has a second gas conduit opposite the rotor from the first gas conduit. A first valve is coupled to the first gas conduit, and is controllable during an expansion mode to selectively permit gas to flow into the turboexpander generator via the first gas conduit. A second valve is coupled to the second gas conduit, and is controllable during a compression mode to selectively permit gas to flow into the turboexpander generator via the second gas conduit. A bidirectional power converter has circuitry to receive alternating current from the stator coils and covert the alternating current into direct current during the expansion mode of operation, The converter also has circuitry to provide an alternating current electrical signal the stator coils during the compression mode of operation.

Certain aspects encompass a method of operating an electric power generation system. According to the method, during an expansion mode of operation of the electric power generation system, gas is directed at a first pressure into a first gas conduit of a turboexpander generator. The gas is then directed at the first pressure into a flow wheel of the turboexpander generator, and expanded through the flow wheel. The gas is then directed at a second, lower pressure out of a second gas conduit of the turboexpander generator. Electric power is generated by rotation of the flow wheel from the expansion of the gas. According to the method, during a compression mode of operation of the electric power generation system, alternating current is supplied to a stator coil of a stator of the turboexpander generator. The alternating current causes a permanent magnet rotor to rotate and the flow wheel to rotate. Gas is drawn into the second gas conduit of the turboexpander generator based on the rotation of the flow wheel, compressed by rotation of the flow wheel, and the compressed gas is directed at a fourth pressure out of the first gas conduit of the turboexpander generator.

Certain aspects encompass a turboexpander generator. The turboexpander generator has a rotor shaft with a node position. The node position defines a position of a node of a first bending mode of the rotor shaft. A flow wheel is removably coupled to the rotor shaft at the node position. The flow wheel is configured receive process gas at a first side of the flow wheel and rotate in response to expansion of the process gas flowing to a second side of the flow wheel. The flow wheel is configured to compress process gas received at the second side of the flow wheel and direct compressed gas out of the first side of the flow wheel when the flow wheel is rotated in response to rotation of the rotor by a rotating magnetic field. The flow wheel and the rotor shaft are configured to rotate together. A stationary stator has a plurality of stator coils. The turboexpander generator is configured to generate an alternating current upon rotation of the rotor within the stator and to rotate the rotor upon energizing the stator coils with an alternating current.

Certain aspects encompass some, none or all of the following features. The flow wheel can have a geometry optimized for one of expansion of gas, compression of gas, or both expansion and compression of gas. The flow wheel can be removably attached to the rotor at a node of a first bending mode of the rotor. The turboexpander generator can have a flow-through design to permit gas to flow from the first gas conduit, through the flow wheel and out of the second gas conduit and to permit gas to flow from the second gas conduit, through the flow wheel, and out the first gas conduit. The stator coils can be configured to radiate a rotating magnetic field when charged by an alternating current supplied from the bidirectional power converter and the rotor can be configured to rotate due to the rotating magnetic field. The turboexpander generator can be releasably coupled to the first valve and the second valve, and configured to reverse direction to couple the first gas conduit to the second valve and to couple the second gas conduit to the first valve. The bidirectional power converter can include an AC-DC converter and a DC-AC inverter. An energy storage device can be included to store electric power generated from the electric power generation system and supply electric power to the stator coils. A variable speed drive can be included to convert electric power generated by the electric power generation system into electric power compatible for delivery to a power grid.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### BRIEF DESCRIPTION OF THE DRAWINGS

FIG. 1 is a schematic diagram of an example turboexpander system in accordance with embodiments of the present disclosure.

FIG. 2 is a schematic diagram illustrating an example turboexpander generator and power electronics used in a bidirectional application in accordance with some implementations of the present disclosure.

FIG. 3A illustrates the turboexpander generator operating in expansion mode in accordance with some implementations of the present disclosure.

FIG. 3B illustrates the turboexpander generator operating in compression mode in accordance with some implementations of the present disclosure.

FIGS. 4A-4B illustrate positioning of modular flow wheels on a rotor in accordance with some implementations of the present disclosure.

FIG. 5 is a schematic diagram illustrating another example turboexpander generator and power electronics used in a bidirectional application in accordance with some implementations of the present disclosure.

FIG. 6 is a process flow diagram for operating a bidirectional flowthrough turboexpander in accordance with some implementations of the present disclosure.

Like reference symbols in the various drawings indicate like elements. Drawings not to scale.

### DETAILED DESCRIPTION

The following detailed description pertains to bidirectional operation of a flowthrough turboexpander generator. The turboexpander generator is bidirectional in the sense that, not only can it generate electrical power (electricity) from flow through the turboexpander generator, it can receive electrical power and operate as a compressor acting on flow supplied to the turboexpander generator. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Natural gas, hydrogen, and other process gases are pressurized to facilitate efficient transportation in pipelines that are sometimes many miles long. The pipelines, for example, transport gases from production sites (e.g., wells) to processing facilities and from processing facilities to local distribution piping networks, such as regional, city or district networks or on site industrial plants networks. To deliver the gas safely through local distribution networks and for use, the process gas is depressurized to lower levels (often using pressure regulators). The pressure is stepped down at pressure letdown (PLD) stations for delivery to industrial, commercial, and residential end users. The PLD stations typically reside at or near the inlet to the local distribution network and use regulating valves to achieve the required pressure drop, but also waste significant amounts of energy in the process. Additional PLD stations and/or regulating valves can be used at other locations for pressure control, such as in the pipelines between the production and processing facilities, within the sub-processes of the processing facilities, and within the end user's processes and piping. A turboexpander generator can be installed in parallel to the regulating valve to perform pressure letdown and recover the wasted energy from pressure reduction and produce electrical power. The electrical power can be directed to a local and/or municipal power grid or elsewhere. Power can also be supplied to the turboexpander generator to cause it to operate as a compressor. When operating as a compressor, the turboexpander generator can compress and/or raise the pressure downstream from the compressor and lower the pressure upstream from the compress. For example, at various stages in the life of a well, the pressure of the gas supplied from the well goes up and down. When the pressure is high, typically in the early life of the well, the turboexpander generator can use the pressure from the well, expanding the gas through the turboexpander, to generate electricity. When the pressure is low, typically later in the life of the well, the turboexpander generator can be operated as a compressor to lower the pressure downstream of the well and draw out gas from the well, improving production. Additionally or alternatively, the turboexpander generator can be operated as a compressor to raise the pressure downstream of the turboexpander generator in a connected pipe or pipeline to supply the gas at a specified pressure, e.g., the pipeline pressure.

Along the same lines, a turboexpander generator can be installed at a gas storage facility (e.g., a pressure tank and/or other storage) at the inlet/outlet of one or more storage tanks to recover high pressure gasses dispensed from a tanker truck, pipeline, and/or other source through the turboexpander generator into the storage tanks and/or recover high pressure gases dispensed from the storage tanks into a tanker truck, pipeline and/or other recipient of the gas. In the context of energy storage via pressure, electric power can be used to power the turboexpander generator to operate as a compressor to compress gas into the storage facility, e.g., at times of inexpensive electric power, when there is excess (relative to demand) electric power, during times of cyclical power generation (e.g., during daytime at a solar power installation or during a windy period at a wind turbine power installation) and/or at other times when electric power is desired to be stored. That electricity is then stored as high pressure gas in the storage facility. Then, when that electric power is wanted, the turboexpander generator can use the pressure from the storage facility, expanding the gas through the turboexpander, to generate electricity.

The bidirectional turboexpander generator is relevant in other applications, such as in a hydrogen liquefaction process where gaseous hydrogen that has been cooled and pressurized is then expanded to a gaseous state. The expansion can be performed through a turboexpander generator to recover the wasted energy from the expansion and produce electrical power. As above, the electrical power can be directed to a power grid or elsewhere, such as used to power compressors or other components of the liquefaction process. In certain instances, the bidirectional turboexpander can be used as a compressor in the liquefaction process.

In yet another example, the bidirectional turboexpander generator can be used in a fuel cell system where a gas fuel is supplied to a fuel cell stack to generate electricity via chemical reaction. The turboexpander generator can be coupled to a source of gas fuel supplied to the fuel cell stack and recover pressure from the gas fuel as it is depressured to the specified pressure of the fuel cell stack. The depressured gas fuel, as a result of the expansion, is cool and can be used in cooling a heat exchange fluid that, in turn, cools the fuel cell stack. The turboexpander generator can be operated as a compressor, such that the gas fuel exiting the turboexpander generator is heated and can be used as a source of heat to heat the heat exchange fluid that, in turn, heats the fuel cell stack. The mode, expansion or compression, can be regulated based on the thermal needs of the fuel cell stack.

In yet another example, the bidirectionally turboexpander generator can be used in an economizer circuit of a cryogenic storage system to generate electric power from expansion of gas from a cryogenic storage tank of the system and to compress gas into a liquid state for resupply into the storage tank.

In each instance, by recovering lost energy from pressure reduction applications, the turboexpander can generate electricity while also reducing CO2 emissions, increasing overall plant efficiency, offsetting electrical costs, and generating additional revenue. The ability to operate in either mode, expansion/power generation or compression, provides the opportunity to reconfigure a process or system and use it for a different purpose depending on the current operational needs.

The power grid that the turboexpander can supply power to (and draw power from) can be a national or regional power grid, a local power grid for a city or district, or a small or microgrid, such as an on-site grid, e.g., at an industrial facility or neighborhood.

Additionally, there may be other applications with pumped mechanical or pumped thermal energy storage where energy is extracted during expansion or energy is added during compression.

This disclosure pertains to a bidirectional flowthrough turboexpander and methods of using the same. More particularly, this disclosure describes a bidirectional flowthrough turboexpander configured to operate as either a compressor or a turboexpander by reversing direction of flow across the assembly. The bidirectional flowthrough turboexpander can be electrically coupled to a bidirectional power converter that either receives AC power from the turboexpander generator during expansion operations or supplies AC power to the turboexpander generator during compression operations. During compression operations, the turboexpander generator is not acting as a generator, but the structure of the turboexpander generator can be the same for both modes of operation. Modes of operations are controlled by controlling the flow of gas into the turboexpander generator and controlling the power circuitry.

A flowthrough turboexpander that is driven with a bidirectional power converter can be configured to change to a compressor by changing the direction of process gas flow across the machine. The gas flow can either be redirected thru the machine with external valving. The bidirectional power converter will allow for power to be directed to and from the process gas. The machine could be designed with fixed hardware that compromises or balances expansion and compression requirements for one configuration of the machine. This single configuration allows operational flexibility with no changes to hardware other than valve positions.

In some implementations, the turboexpander generator can be flipped so that high-pressure gas from the downstream application can be expanded by the turboexpander generator to generate electricity via expansion of the gas, as described in more detail below.

In some implementations, the turboexpander generator can be converted into a compressor through leveraging the modularity of certain components, such as a modular flow wheel. A flow wheel can be removed and replaced by a compressor wheel to support compression capabilities. The funnel at the immediate exit of the wheel could be profiled to direct the radial outlet into an inlet discharge with high efficiency. Certain modular components can be changed to optimize operation as either an expander or compressor for a prolonged period of time (e.g. for seasonal energy storage, end of well life, etc.)

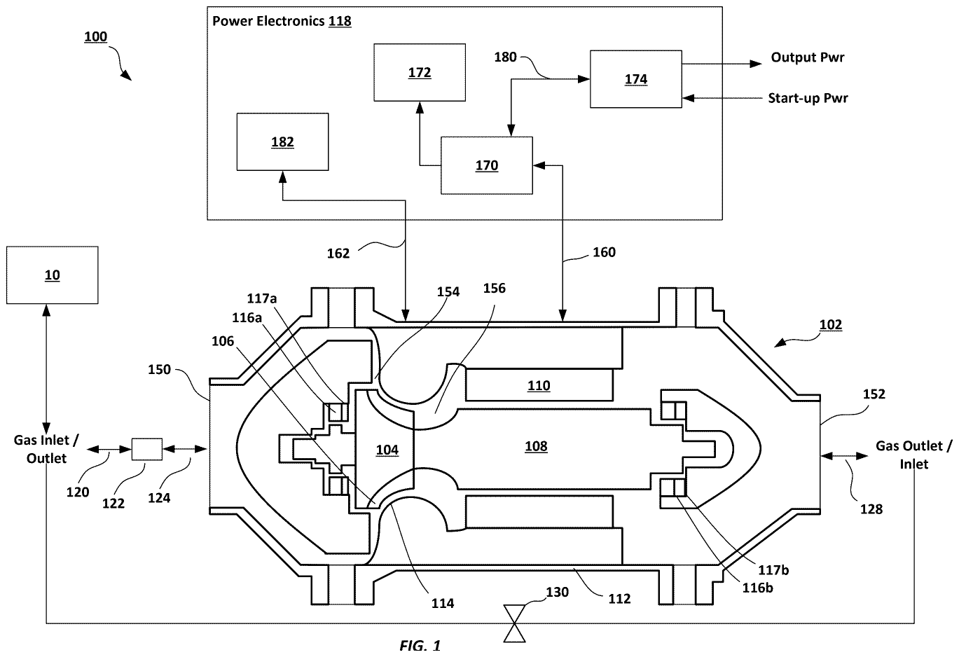

FIG. 1 is a schematic diagram of an electric power generation system 100 coupled to a companion system 10 in accordance with embodiments of the present disclosure. The electric power generation system 100 includes a bidirectional turboexpander generator 102. In the context of a PLD station, the companion system 10 could be a wellhead of a well, a manifold of a gathering network connecting and receiving flow from multiple wells, a pipeline or pipe, a local distribution piping network, a process for generating and/or outputting hydrogen or another gas, a gas storage facility, and/or another source of high pressure gas. In the context of gas storage and/or energy storage via compressed gas, the companion system 10 could be a gas storage facility. In the context of a hydrogen liquefaction process, the companion system 10 could be the liquefaction process or an aspect of the process. In the context of fuel cell system, the companion system 10 could be the fuel cell system or an aspect of the system. In each instance, the bidirectional turboexpander generator 102 is configured to receive pressurized gas from and supply pressurized gas to the companion system 10. In the context of a cryogenic storage system, the companion system 10 could be the economizer circuit and storage tank of the system.

The turboexpander generator 102 is arranged axially so that the turboexpander generator 102 can be mounted in-line with a pipe, in a flowthrough configuration. The turboexpander generator 102 can operate as an electric generator by generating electrical energy from rotational kinetic energy derived from expansion of an operating gas through a flow wheel 104. For example, rotation of the flow wheel 104 can be used to rotate a rotor 108 within a stator 110, which then generates electrical energy. The turboexpander generator 102 is designed to have the operating as flow through the system, which cools the generator section and eliminates the need for auxiliary cooling equipment. The operating gas can include vaporized cryogenic fluid, including one or a combination of oxygen, nitrogen, argon, hydrogen, or helium. Other cryogenic fluids can also be used as an operating as without deviating from the scope of this disclosure. After expansion, the gas exits the turboexpander generator 102 along the same axial path for downstream processes.

The turboexpander generator 102 includes a high-performance, high-speed permanent magnet generator with an integrated radial in-flow expansion flow wheel 104 and low loss active magnetic bearings (AMBs) 116a, b. The rotor assembly consists of the permanent magnet section with the flow wheel 104 mounted directly to the rotor 108 by a rotor hub. Rotor 108 is levitated by the magnetic bearing system creating a frictionless (or near frictionless) interface between dynamic and static components. The AMBs 116a, b facilitate a lossless (or near lossless) rotation of the rotor 108. AMBs 116a, b are described in more detail later.

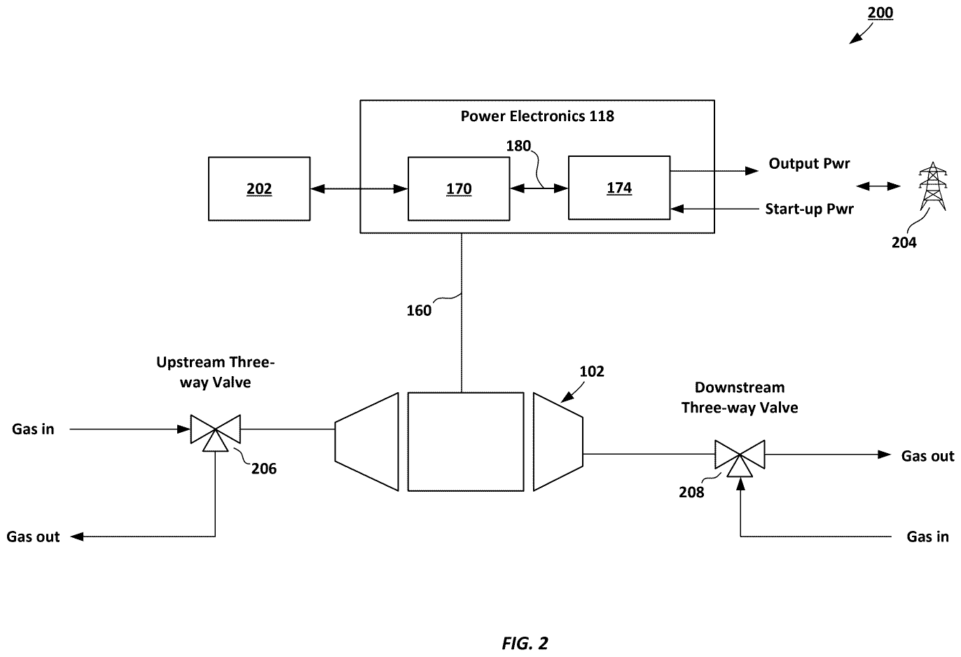

The turboexpander generator 102 includes a flow-through configuration. The flow-through configuration permits operating gas to flow from an inlet side of the turboexpander generator 102 to an outlet side of the turboexpander generator 102. The operating gas can be caused to flow into a radial gas inlet 154 to a flow wheel 104 and an axial gas outlet 156 from the flow wheel 104. The operating gas can then flow through the generator from the outlet 156 of the flow wheel through the generator (i.e., between the rotor 108 and stator 108, and out of the outlet 156, where the operating gas can be introduced into another system (in FIGS. 2A-2B, the expanded operating gas is sent back to the cryogenic vessel 202). Generally, the operating gas has a pressure sufficiently high is directed to flow into the turboexpander generator 102 through a flow control system. The flow control system can include one or more of a flow or mass control valve, a fast stop valve, a slam valve, an isolation valve, and an emergency shut off valve. In embodiments, any number of valves can be positioned upstream of inlet conduit 150 for various purposes, including flow or pressure control, emergency shutdown, and fluid isolation. The term “flow control system” is used herein to refer to one or more valves for controlling the flow of gas into the inlet conduit 150.

The high pressure process gas 120 is expanded by flowing through the flow wheel 104, resulting in a pressure letdown of the process gas. Lower pressure process gas 128 exits the turboexpander. The expansion of the high pressure process gas 120 through the flow wheel 104 causes the flow wheel 104 to rotate, which causes the rotor 108 to rotate. The rotation of the rotor 108 within the stator 110 generates electrical energy. The turboexpander generator 102 achieves the desired pressure letdown and captures the energy from the pressure letdown to generate electricity. A pressure control valve 130, such as a conventional pressure regulator, can be installed in parallel to the turboexpander generator 102. The pressure control valve 130 can be used to control the pressure of the high pressure process gas 120 that flows through the turboexpander. Any excess high pressure process gas that is not directed into the turboexpander can be directed through the pressure control valve 130.

In some embodiments, a heater 122 can heat the high pressure process gas 120 prior to flowing the gas into the turboexpander generator 102. For example, if the expansion of the gas through the flow wheel 104 lowers the temperature of the process gas to a point where moisture in the gas freezes at the flow wheel or other downstream locations in the pipeline, the pressurized process gas 120 can be heated by heater 122. Heated high pressure process gas 124 can then be directed into the turboexpander generator 102. The heating of the process gas can prevent freezing moisture as the gas expands and its temperature drops.

The flow wheel 104 is shown as a radial inflow flow wheel, though other configurations are within the scope of this disclosure, such as axial flow wheels. In this example, heated high pressure process gas 124 is received from an inlet conduit 150 of the housing 112 enters a radially oriented inlet 154 of the flow wheel 104. In certain embodiments, the fluid flows through an inlet conduit 150 and is diverted by a flow diverter to a radial inlet 154 that directs the flow into the radial inflow of the flow wheel 104. After expanding, the lower pressure process gas exits the flow wheel 104 from an axially oriented outlet 156 to outlet conduit 152 of the housing 112.

The flow wheel 104 can be directly affixed to the rotor 108, or to an intermediate common shaft, for example, by fasteners, rigid drive shaft, welding, or other manner. For example, the flow wheel 104 may be received at an end of the rotor 108, and held to the rotor 108 with a shaft. The shaft threads into the rotor 108 at one end, and at the other, captures the flow wheel 104 between the end of rotor 108 and a nut threadingly received on the shaft. The flow wheel 104 and rotor 108 can be coupled without a gearbox and rotate at the same speed. In other instances, the flow wheel 104 can be indirectly coupled to the rotor 108, for example, by a gear train, clutch mechanism, or other manner.

The flow wheel 104 includes a plurality of flow wheel blades 106 extending outwardly from a hub and that react with the expanding process gas to cause the flow wheel 104 to rotate. FIG. 1 shows an unshrouded flow wheel, in which each of the blades 106 has an exposed, generally radially oriented blade tip extending between the radial inlet 154 and axial outlet 156. As discussed in more detail below, the blade tips substantially seal against a shroud 114 on the interior of the housing 112. In certain instances, the flow wheel 104 is a shrouded flow wheel.

In configurations with an un-shrouded flow wheel 104, the housing 112 includes an inwardly oriented shroud 114 that resides closely adjacent to, and at most times during operation, out of contact with the flow wheel blades 106. The close proximity of the flow wheel blades 106 and shroud 114 substantially seals against passage of process gas therebetween, as the process gas flows through the flow wheel 104. Although some amount of the process gas may leak or pass between the flow wheel blades 106 and the shroud 114, the leakage is insubstantial in the operation of the flow wheel 104. In certain instances, the leakage can be commensurate with other similar unshrouded-wheel/shroud-surface interfaces, using conventional tolerances between the flow wheel blades 106 and the shroud 114. The amount of leakage that is considered acceptable leakage may be predetermined. The operational parameters of the turboexpander generator may be optimized to reduce the leakage. In embodiments, the housing 112 is hermetically sealed to prevent process gases from escaping the radial inlet 154 of the flow wheel 104.

The shroud 114 may reside at a specified distance away from the flow wheel blades 106, and is maintained at a distance away from the flow wheel blades 106 during operation of the turboexpander generator 102 by using magnetic positioning devices, including active magnetic bearings and position sensors.

In some implementations, the turboexpander generator 102 can operate as a compressor. The flow wheel 104 can be powered by an external power source, such as an energy storage device or a power grid. Application of an AC signal through the stator coils can cause the rotor to rotate, thereby rotating the flow wheel 104. Gas can be introduced from a downstream side of the turboexpander generator 102 into the outlet conduit 152 and caused to flow through the turboexpander generator 102 across the rotor towards the flow wheel 104. The gas can flow into the flow wheel 104 through the axial gas outlet 156, which is operating as an inlet. The gas can be compressed by the rotating flow wheel 104. Compressed gas can be output from the flow wheel 104 via radial gas inlet 154 and out of the inlet conduit 150. The inlet conduit 150 and radial gas inlet 154 are collectively profiled to collect the compressed gas from the flow wheel 104 efficiently and redirect it from a radial flow through the radial gas inlet 154 (which is operating as an outlet) to an axial, inline flow discharging through the inlet conduit 150 (which is operating as an outlet). In certain instances, the flow wheel 104 can be configured to operate both as a turbine and as a compressor, with the aerodynamics of the wheel 104 balanced between the dual purposes. In other instances, the flow wheel 104 can be interchanged, using a wheel configured as a turbine for use in expanding gas through the turboexpander generator 102 and using a wheel configured as a compressor for use in compressing gas through the turboexpander generator 102.

Bearings 116a and 116b are arranged to rotatably support the rotor 108 and flow wheel 104 relative to the stator 110 and the shroud 114. The flow wheel 104 is supported in a cantilevered manner by the bearings 116a and 116b. In embodiments, the flow wheel 104 may be supported in a non-cantilevered manner and bearings 116a and 116b may be located on the outlet side of flow wheel 104. In certain instances, one or more of the bearings 116a or 116b can include ball bearings, needle bearings, magnetic bearings, foil bearings, journal bearings, or others.

Bearings 116a and 116b may be a combination radial and thrust bearing, supporting the rotor 108 in radial and axial directions. Other configurations could be utilized. The bearings 116a and 116b need not be the same types of bearings.

Position sensors 117a, 117b can be used to detect the position or changes in the position of the flow wheel 104 and/or rotor 108 relative to the housing 112 or other reference point (such as a predetermined value). Position sensors 117a, 117b can detect axial and/or radial displacement. The magnetic bearing 116a and/or 116b can respond to the information from the positions sensors 117a, 117b and adjust for the detected displacement, if necessary.

In the embodiments in which the bearings 116a and 116b are magnetic bearings, the turboexpander generator 102 is connected to a magnetic bearing control circuitry (MBC) 182 in power electronics 118 to control the magnetic bearings 116a and 116b. The MBC 182 constantly monitors position, current, temperature, and other parameters via MBC control bus 162 to ensure that the turboexpander generator 102 and the active magnetic bearings 116a and 116b are operating as desired. The MBC 182 may receive information from the position sensor(s) 117a, 117b and process that information to provide control signals to the magnetic bearings 116a, 116b. For example, the MBC 182 is coupled to position sensors 117a, 117b by MBC control bus 162 to monitor radial and axial position of the flow wheel 104 and the rotor 108.

The MBC 182 can control the magnetic bearings 116a, 116b to selectively change the stiffness and damping characteristics of the magnetic bearings 116a, 116b as a function of spin speed. The MBC 182 can also cause the magnetic bearings to increase or decrease position separation to maintain consistent rotational spin without the moving components impinging on stationary components. The turboexpander generator 102 can include sensors that monitor rotor speed that are connected to the MBC 182. The MBC 182, therefore, can monitor rotor speed and position of the rotational elements. The MBC 182 can also control synchronous cancellation, including automatic balancing control, adaptive vibration control, adaptive vibration rejection, and unbalance force rejection control. MBC 182 can communicate with the various components of the turboexpander generator 102 across a communications channel such as MBC control bus 162.

The use of magnetic bearings 116a, 116b and position sensors 117a, 117b to maintain and/or adjust the position of the flow wheel blades 106 such that the flow wheel blades 106 stay in close proximity to the shroud 114 permits the turboexpander generator 102 to operate without the need for seals (e.g., without the need for dynamic seals). The use of the active magnetic bearings 116a, b in the turboexpander generator 102 eliminates physical contact between rotating and stationary components, as well as eliminate lubrication, lubrication systems, and seals.

The turboexpander generator 102 may include one or more backup bearings. For example, at start-up and shut-down or in the event of a power outage that affects the operation of the magnetic bearings 116a and 116b, bearings may be used to rotatably support the flow wheel 104 during that period of time. The backup bearings and may include ball bearings, needle bearings, journal bearings, or the like.

As mentioned previously, the turboexpander generator 102 is configured to generate electricity in response to the rotation of the rotor 108. In certain instances, the rotor 108 can include one or more permanent magnets. The stator 110 includes a plurality of conductive coils. Electrical current is generated by the rotation of the permanent magnets coupled to the rotor 108 within the coils of the stator 110. The rotor 108 and stator 110 can be configured as a synchronous, permanent magnet, multiphase alternating current (AC) generator. The electrical output of the turboexpander generator 102 can be a three-phase output, for example. In certain instances, stator 110 may include a plurality of coils (e.g., three or six coils for a three-phase AC output). When the rotor 108 is rotated, a voltage is induced in the stator coil. At any instant, the magnitude of the voltage induced in coils is proportional to the rate at which the magnetic field encircled by the coil is changing with time (i.e., the rate at which the magnetic field is passing the two sides of the coil). In instances where the rotor 108 is coupled to rotate at the same speed as the flow wheel 104, the turboexpander generator 102 is configured to generate electricity at that speed. Such a turboexpander generator 102 is what is referred to as a “high speed” turboexpander generator. For example, in embodiments, the turboexpander generator 102 can produce up to 280 kW at a continuous speed of 30,000 rpm. In embodiments, the turboexpander can produce on the order of 350 kW at higher rotational speeds (e.g., on the order of 35,000 rpm). Other power output magnitudes are within the scope of this disclosure.

The electric power generation system 100 can include power electronics 118. Power electronics 118 in general can receive output power from the turboexpander generator 102 and can output electricity to power a desired load or to send power to a grid (depending on the output of the turboexpander generator 102). Power electronics 118 can also send power to the turboexpander generator 102 for start-up operations. For example, the power electronics 118 can include a bidirectional power converter 170. Bidirectional power converter 170 can include hardware circuitry to convert AC power from the turboexpander generator 102 into DC power for the DC bus 180. The bidirectional power converter 170 receive AC power from the turboexpander generator 102 and convert the AC power into DC power having an amplitude compatible for a DC bus 180. That is, the bidirectional power converter 170 can perform AC to DC conversion, as well as scaling, filtering, and other functions.

The bidirectional power converter 170 includes circuit elements to perform DC to AC conversion to convert DC power from the DC bus 180 into AC power compatible for operating the turboexpander generator 102. The bidirectional power converter 170 can also perform DC to AC conversion, to supply power from the DC bus to the turboexpander generator 102 for start-up operations. The bidirectional power converter 170 can also be used to rotate the rotor by directing an alternating current through the windings of the stator (i.e., the stator coils). The current produces a rotating magnetic field that interacts with permanent magnets on the rotor, causing the rotor to rotate to act as a compressor wheel. Thus, AC signal through the stator coils causing the rotor to rotate can facilitate the turboexpander generator to operate as a compressor. The power on the DC bus 180 can originate from a battery or energy storage device (e.g., energy storage device 202) or from a power grid 204.

Bidirectional power converter 170 can also be referred to as a bidirectional power inverter or other similar terms.

The DC power output from the bidirectional power converter 170 can be input into a variable speed drive (VSD) 174. The VSD 174 allows for a consistent and clean delivery of generated power from the turboexpander 102 to a load. The VSD 174 regulates the frequency and amplitude of the generated current output from the turboexpander generator 102 to match the load. In some implementations, the VSD 174 can include one or more of a DC-AC converter, a DC-DC converter, a bidirectional power converter, similar to bidirectional power converter 170, and other circuit elements. Other circuit elements can include transformer circuits, rectifier circuits, filters, waveform generators, pulse generators, etc. that the VSD 174 can use to output a power signal that matches the load requirements. For example, in some implementations, the VSD 174 can output DC power for operating a pump to pump cryogenic fluid output from the turboexpander generator into a cryogenic vessel, as described in FIGS. 2A-2B.

In some embodiments, the power electronics 118 includes a brake resistor assembly 172 that is electrically connected to an output of the bidirectional power converter 170 (as shown in FIG. 1) or can be connected to the electrical output 160 of the turboexpander generator 102 across an active rectifier (not shown). The brake resistor assembly 172 can have a tuned impedance to allow an efficient transfer of power from the turboexpander generator 102 to the brake resistor assembly 172. The brake resistor assembly 172 can include one or more circuit elements that are selected so the brake resistor impedance matches the impedance of the turboexpander. The brake resistor 172 can be used to prevent or reduce the impact of an overspeed condition.

The VSD 174 can also be used to condition input power for controlling the turboexpander generator 102 (e.g., for operating the turboexpander generator 102 as a compressor). Power received from an external source, such as a power grid or energy storage device, can be received by the VSD 174 and conditioned by the VSD 174 for powering up various components of the turboexpander generator 102, including the MBC 182. Conditioned external power can also be used to control rotation of the rotor 108 within the stator 110. The power supplied to the stator 110 can be based on the desired gas pressure output from the turboexpander generator 102.

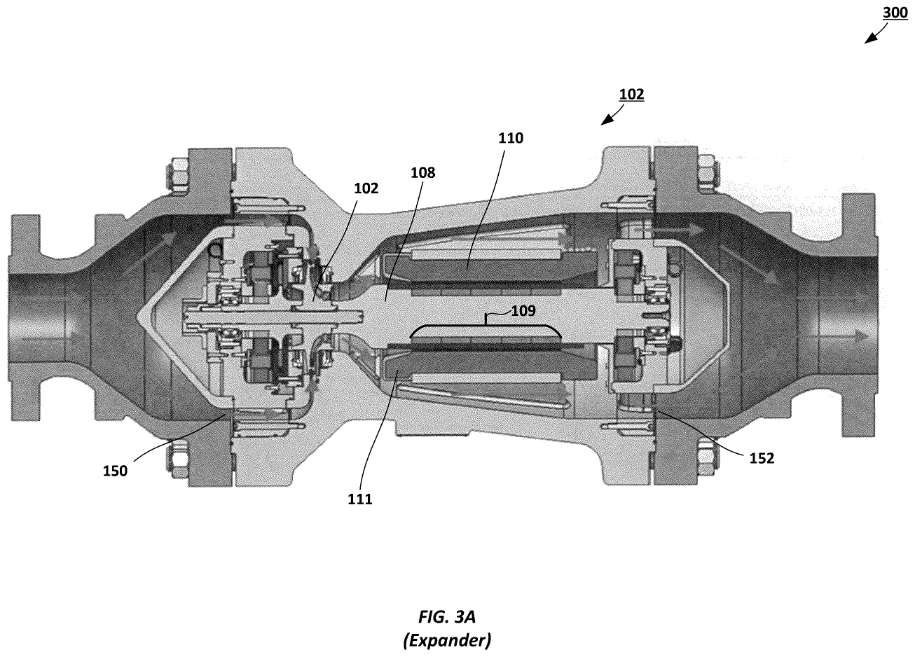

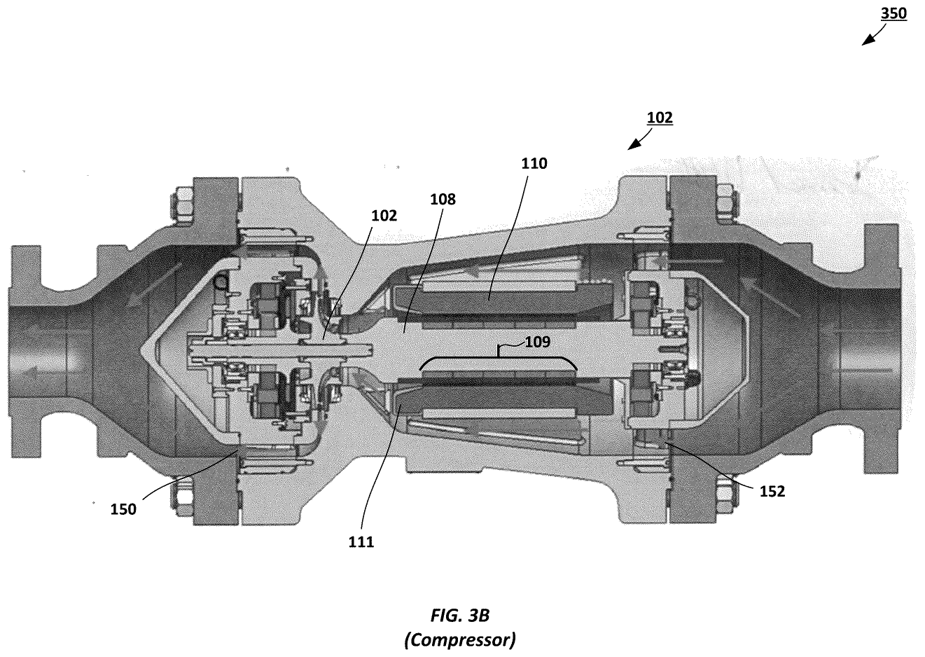

FIG. 2 is a schematic diagram 200 illustrating an example turboexpander generator and power electronics used in a bidirectional application in accordance with some implementations of the present disclosure. The example of FIG. 2 can be used in the context of FIG. 1. FIG. 3A illustrates the turboexpander generator 102 operating in expansion mode in accordance with some implementations of the present disclosure; FIG. 3B illustrates the turboexpander generator 102 operating in compression mode in accordance with some implementations of the present disclosure. FIGS. 2 & 3A-3B can be discussed together. The turboexpander generator 102 inlet conduit can be coupled to an upstream valve 206, which is shown in FIG. 2 as a three-way valve. The “Gas in” and “Gas out” at valve 206 can be supplied from/to the companion system (e.g., companion system 10) The turboexpander generator 102 outlet conduit 152 can be coupled to a downstream valve 208, which is also shown as a three-way valve. In an expansion mode, where high pressure gas flows into the turboexpander generator 102 from the upstream side, the upstream valve 208 can be opened to permit gas flow into the inlet conduit 150 of the turboexpander generator 102. The high-pressure gas can be expanded by the flow wheel 104, and cause the flow wheel 104 to rotate to generate electricity. The expanded gas can be directed through the turboexpander generator 102 and out the outlet conduit 152 into the downstream valve 208 and out to downstream applications. Power generated by the turboexpander generator 102 can be supplied to the power electronics 118 through the bidirectional power converter 170 destined to either the energy storage device 202 (e.g., a battery or other type of energy storage device) or to the grid 204 (e.g., via VSD 174).

In compression mode, the turboexpander generator 102 can be powered by energy supplied by the energy storage device 202 or the power grid 204 through the bidirectional power converter 170. Depending on the pressure of the input gas and the desired pressure of the output gas, an appropriate AC signal can be supplied to the stator coils to cause the rotor to rotate, thereby rotating the flow wheel. The rotor and flow wheel can be controlled such that the flow wheel draws gas from the downstream side into the outlet conduit of the turboexpander generator 102. The downstream valve 208 can be open to allow gas to flow from the downstream side to the outlet conduit of the turboexpander generator 102. The gas can be drawn into the turboexpander generator 102 via pressure differential created by the rotation of the flow wheel. The gas can be compressed by the flow wheel. The compressed gas can be output from the inlet conduit of the turboexpander generator when the upstream valve 206 open to an output position. The compressed gas can be stored or used, as desired.

In some implementations, two separate valves can be used to direct gas either into or out of the turboexpander generator inlet conduit. Likewise, two separate valves can be used to direct gas either into or out of the turboexpander generator outlet conduit.

The turboexpander generator can be designed with fixed hardware that compromises or balances expansion and compression requirements for one configuration of the machine. This single design could allow operational flexibility with no changes to hardware other than valve positions. Specifically, the flow wheel with a certain geometry that facilitates a balance between both expansion and compression modes of operation can be coupled to the rotor. The design of the flow wheel can also be selected to balance interests between expansion and compression. That is, if expansion is the more likely use-case, then the flow wheel can be selected that is more balanced towards expansion operations than compression operations.

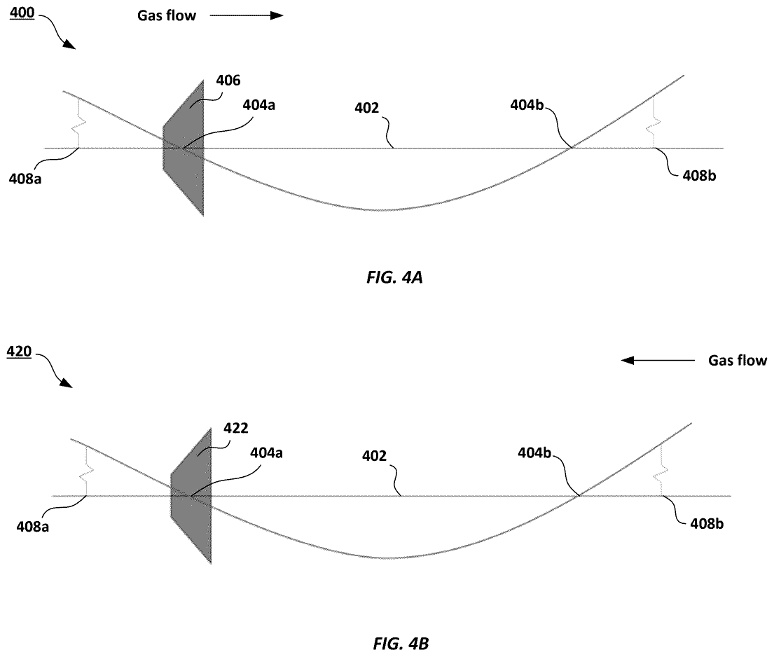

In some implementations, the modular nature of the turboexpander generator 102 means that a specific flow wheel can be coupled to the rotor for the desired application. For example, for expansion applications, a turbine type flow wheel can be selected that is optimized for gas expansion; and for compression applications, a compressor type flow wheel can be selected that is optimized for gas compression. FIGS. 4A-B are schematic diagrams illustrating example wheel locations along a rotor shaft in accordance with embodiments of the present disclosure. FIGS. 4A-4B show a turboexpander 400 and 420. Each of turboexpander 400 and 420 includes a rotor shaft 402 supported by magnetic bearings 408a and 408b. The rotor shaft 402 has two nodes 404a and 404b. For example, FIG. 4A shows a first configuration of a turboexpander 400 that includes a flow wheel 406 that may be optimized for expansion. In turboexpander 400, the process gas flows from the upstream side to the downstream side (from left to right in the drawing). The wheel 406 is positioned at node 404a. FIG. 4B shows a second configuration of a turboexpander 420 that uses a flow wheel 422 that is optimized for compression. In turboexpander 420, the process gas flows from the downstream side to the upstream side (from right to left in the drawing). The flow wheel 422 is also positioned at node 404a.

A first bending mode sinusoid being mapped to a rotor shaft 402 illustrates the location of two bending mode nodes 404a and 404b. A node is identified as a point along the first bending mode sinusoid where the first bending mode sinusoid crosses the center (0 inches of shaft radius) of the rotor shaft 402. The first bending mode shape is tuned in such a way that the center of mass of the wheel is placed on the node 404a with the magnetic bearing support locations 408a and 408b outside the flow wheel 406. Bearing targets or sections of the rotor can be adjusted to correctly place the wheel onto node 306.

As can be seen in FIGS. 4A-4b, a node exists in two places along the rotor shaft 402 (e.g., at first node position 404a and at second node position 404b). A flow wheel 406 or 422 or other type of wheel can be placed on either side or both sides of the rotor shaft 402 with both magnetic bearings placed outside of both wheels.

Placing the wheel at the node of the rotor shaft 402 allows for the turboexpander generator 102 to use an integrated aero design, as opposed to an overhung machine, where the aero section is bolted on the end of the machine. The magnetic bearings support the integrated aero design. The flow wheel placement at the node of the rotor shaft facilitates the integrated aero design without compromising the magnetic bearings. The flow wheel placement does not impact balance or oscillation, allowing the magnetic bearings to support the rotation of the rotor within the stator while also accommodating for variation in flow wheel selection. Put simply, a heavier or lighter flow wheel does not affect the magnetic bearing's support of the rotor shaft as the rotor shaft rotates. Any first mode oscillation or vibration of the rotor shaft during rotation is not sensitive to mass or inertia at the node.

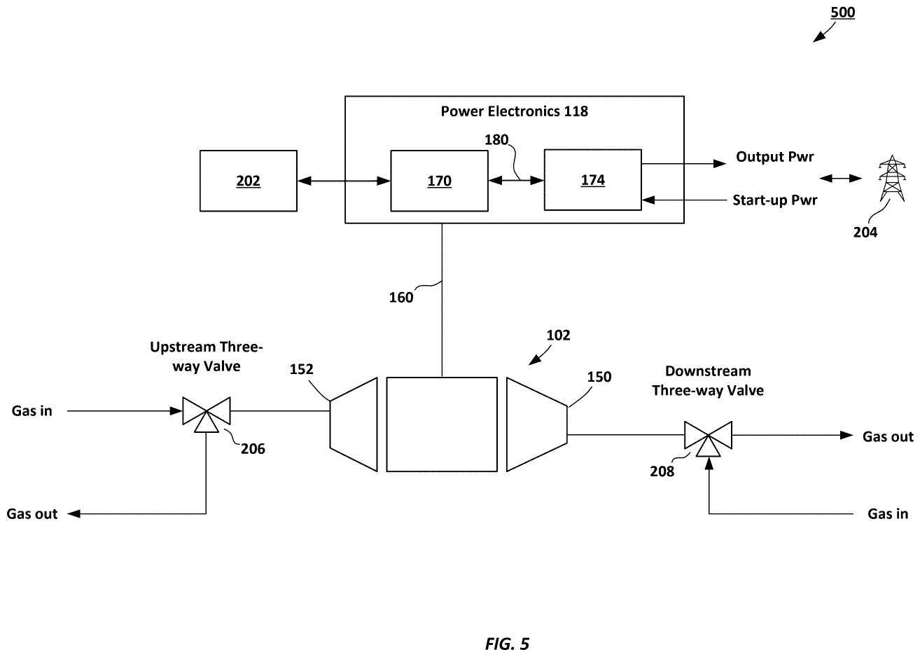

FIG. 5 is a schematic diagram 500 illustrating another example turboexpander generator and power electronics used in a bidirectional application in accordance with some implementations of the present disclosure. In FIG. 5, the turboexpander generator 102 is flipped so that the inlet conduit is coupled to the downstream valve 208 and the outlet conduit is coupled to the upstream valve 206.

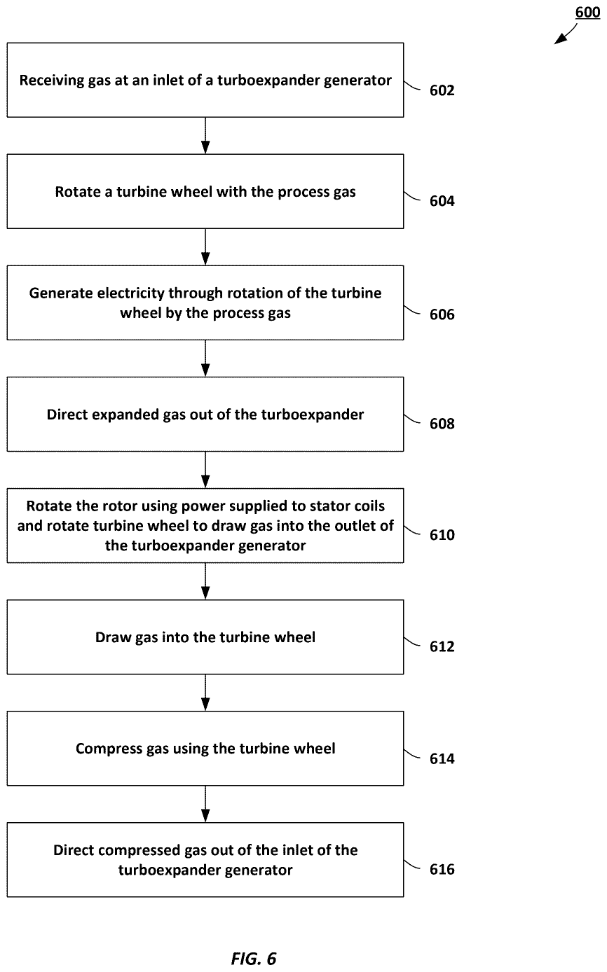

FIG. 6 is a process flow diagram for operating a bidirectional flowthrough turboexpander in accordance with some implementations of the present disclosure. A turboexpander generator can operate in an expansion mode or a compression mode. In expansion mode, at 602, an upstream valve can be controlled to permit gas to flow from the upstream side into an inlet conduit of the turboexpander generator. At 604, the gas causes a flow wheel of the turboexpander generator to rotate. The flow wheel is coupled to a rotor with embedded permanent magnets, and the rotor rotates within a stator upon rotation of the flow wheel. At 606, rotation of the rotor within the stator generates AC electricity, which is output to a bidirectional power converter. The bidirectional power converter can convert the AC electricity to DC for storage or for further power conversion for a load or grid. At step 608, the expanded gas from the flow wheel is directed to an outlet conduit for downstream applications. The expanded gas can have a desired pressure based on the downstream applications. The expanded gas can be channeled to the downstream application by a downstream valve.

In compression mode, at 610, the bidirectional power converter can deliver AC signals to the stator coils that cause the rotor to rotate. Rotation of the rotor causes rotation of the flow wheel. Rotation of the flow wheel causes gas to be drawn into the turboexpander generator outlet conduit. At 612, downstream valve can be controlled to permit gas from a downstream application to enter the outlet conduit of the turboexpander, which is drawn into the turboexpander by rotation of the flow wheel. At 614, rotation of the flow wheel compresses the gas. At 616, the compressed gas is output from the inlet conduit of the turboexpander generator and directed through the upstream valve to gas storage or to an application.

The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment. In the foregoing specification, a detailed description has been given with reference to specific exemplary embodiments. It will, however, be evident that various modifications and changes may be made thereto without departing from the broader spirit and scope of the disclosure as set forth in the claims.

1. An electric power generation system comprising:
a turboexpander generator comprising:
a first gas conduit,
a flow wheel, the flow wheel configured to rotate in response to gas expanding through the flow wheel during an expansion mode of operation and to rotate to compress gas during a compression mode of operation,
an electric rotor coupled to the flow wheel and configured to rotate with the flow wheel, the rotor comprising a plurality of permanent magnets,
a stator comprising a plurality of stator coils, and
a second gas conduit opposite the rotor from the first gas conduit, the second gas conduit in fluid communication with the first gas conduit to direct gas from the first gas conduit, across the rotor and stator coils, and to the second gas conduit and vice versa;
a first valve coupled to the first gas conduit, the first valve controllable during the expansion mode to selectively permit gas to flow into the turboexpander generator via the first gas conduit;
a second valve coupled to the second gas conduit, the second valve controllable during the compression mode to selectively permit gas to flow into the turboexpander generator via the second gas conduit; and
a bidirectional power converter comprising:
circuitry to receive alternating current from the stator coils and covert the alternating current into direct current during the expansion mode of operation, and
circuitry to provide an alternating current electrical signal to the stator coils during the compression mode of operation.

2. The electric power generation system of claim 1, wherein the flow wheel comprises a geometry optimized for one of expansion of gas, compression of gas, or both expansion and compression of gas.

3. The electric power generation system of claim 1, wherein the flow wheel is removably attached to the rotor at a node of a first bending mode of the rotor.

4. The electric power generation system of claim 1, wherein the turboexpander generator comprises a flow-through design to permit gas to flow from the first gas conduit, through the flow wheel and out of the second gas conduit and to permit gas to flow from the second gas conduit, through the flow wheel, and out the first gas conduit.

5. The electric power generation system of claim 1, wherein the stator coils are configured to radiate a rotating magnetic field when charged by an alternating current supplied from the bidirectional power converter; and wherein the rotor is configured to rotate due to the rotating magnetic field.

6. The electric power generation system of claim 1, wherein the turboexpander generator is releasably coupled to the first valve and the second valve, and is configured to reverse direction to couple the first gas conduit to the second valve and to couple the second gas conduit to the first valve.

7. The electric power generation system of claim 1, wherein the bidirectional power converter comprises an AC-DC converter and a DC-AC inverter.

8. The electric power generation system of claim 1, further comprising an energy storage device to:
store electric power generated from the electric power generation system; and
supply electric power to the stator coils.

9. The electric power generation system of claim 1, further comprising a variable speed drive to convert electric power generated by the electric power generation system into electric power compatible for delivery to a power grid.

10. A method of operating an electric power generation system, the method comprising:
during an expansion mode of operation of the electric power generation system:
directing gas at a first pressure into a first gas conduit of a turboexpander generator,
directing the gas at the first pressure into a flow wheel of the turboexpander generator,
expanding the gas using the flow wheel,
directing gas at a second, lower pressure through the turboexpander generator and out of a second gas conduit of the turboexpander generator, and
generating electric power by rotation of the flow wheel from the expansion of the gas; and
during a compression mode of operation of the electric power generation system:
supplying alternating current to a stator coil of a stator of the turboexpander generator, the alternating current causing a permanent magnet rotor to rotate and causing the flow wheel to rotate,
drawing gas into the second gas conduit and through the turboexpander generator based on the rotation of the flow wheel,
compressing the gas by rotation of the flow wheel, and
directing the compressed gas at a third pressure out of the first gas conduit of the turboexpander generator.

11. The method of claim 10, wherein the flow wheel is optimized for expansion of gas, the method further comprising:
determining to change operating mode from the expansion mode to the compression mode;
removing the flow wheel; and
coupling a second flow wheel optimized for the compression mode to the rotor.

12. The method of claim 11, wherein coupling the second flow wheel to the rotor comprises coupling the second flow wheel to a node of a first bending mode of the rotor.

13. The method of claim 10, further comprising:
prior to operating the electric power generation system in the expansion mode of operation:
controlling a first valve coupled to the first gas conduit to permit gas to flow from a first side of the turboexpander generator into the first gas conduit; and
controlling a second valve coupled to the second gas conduit to permit expanded gas to flow from the second gas conduit to a downstream location.

14. The method of claim 10, further comprising:
prior to operating the electric power generation system in the compression mode of operation:
controlling a first valve coupled to the first gas conduit to permit compressed gas to flow from the first gas conduit out of the turboexpander generator via the first gas conduit; and
controlling a second valve coupled to the second gas conduit to permit gas to flow from a downstream location into the second gas conduit.

15. The method of claim 10, further comprising:
during the expansion mode of operation:
directing alternating current generated by the turboexpander generator into a bidirectional power converter,
converting the alternating current to direct current, and
directing the direct current on a direct current bus to one of an energy storage device or to a variable speed drive; and
during the compression mode of operation:
directing alternating current from the bidirectional power converter to each stator coil of the stator, the alternating current generating a rotating magnetic field from the alternating current.

16. A turboexpander generator comprising:
a rotor shaft comprising a node position, the node position defining a position of a node of a first bending mode of the rotor shaft;
a flow wheel removably coupled to the rotor shaft at the node position, the flow wheel configured to:
receive process gas at a first side of the flow wheel and rotate in response to expansion of the process gas flowing to a second side of the flow wheel, and
compress process gas received at the second side of the flow wheel and direct compressed gas out of the first side of the flow wheel when the flow wheel is rotated in response to rotation of the rotor shaft by a rotating magnetic field, and
wherein the flow wheel and the rotor shaft are configured to rotate together; and
a stationary stator comprises a plurality of stator coils, the turboexpander generator to generate an alternating current upon rotation of the rotor shaft within the stator and to rotate the rotor upon energizing the stator coils with an alternating current;
wherein rotation of the flow wheel causes gas to flow through the turboexpander generator.

17. The turboexpander generator of claim 16, wherein the flow wheel is optimized for one of expansion or compression of the process gas.

18. The turboexpander generator of claim 16, wherein the turboexpander generator is configured to permit gas to flow axially across the rotor shaft and/or stator through the turboexpander generator between a first conduit of the turboexpander generator and a second conduit of the turboexpander generator, the first conduit proximate the first side of the flow wheel and the second conduit proximate a distal end of the rotor shaft opposite the flow wheel.

19. The turboexpander generator of claim 18, a flow passage between the first conduit of the turboexpander generator and the flow wheel is part axial and part radial, and where the passage is profiled to collect compressed gas exiting radially from the flow wheel and redirect the gas axially.

20. The turboexpander generator of claim 16, wherein the flow wheel comprises a geometry to perform both expansion and compression.

21. The turboexpander generator of claim 16, further comprising a bidirectional power converter comprising:
circuitry to receive alternating current from the stator coils and covert the alternating current into direct current during an expansion mode of operation, and
circuitry to provide an alternating current electrical signal to the stator coils during a compression mode of operation.
